(19) United States
(12) Patent Application Publication
(10) Pub. No.: US 2008/0141071 A1
(43) Pub. Date: Jun. 12, 2008

(54) Pre-Mortem Waveform Trace Generation for Hardware Description Language Simulators

(76) Inventors: Stephen C. Bergman, Pflugerville, TX (US); Tilman Gloekler, Gaertringen (DE); Klaus Heinzelmann, Aichtal-Grotzingen (DE); Ulla Herter, Stuttgart (DE); Karl Heinz Uhl, Weil lm Schonbuch (DE)

Correspondence Address: IBM CORP (YA);C/O YEE & ASSOCIATES PC, P.O. BOX 802333, DALLAS, TX, 75380, US

(21) Appl. No.: 11/608,911

(22) Filed: Dec. 11, 2006

(51) Int. Cl. G06F 11/34

(52) U.S. Cl. 714/33; 714/45; 714/E11.199

(57) ABSTRACT

A computer implemented method, system and computer program product for providing a waveform trace of a last plurality of cycles of a simulation prior to occurrence of an error in the simulation. A computer implemented method in a data processing system for providing a waveform trace for a last plurality of cycles of a simulation prior to occurrence of an error in the simulation includes storing history information relating to a last plurality of cycles of a simulation during running of the simulation. Responsive to an error occurring in the simulation, the simulation is stopped, and a waveform trace for the last plurality of cycles of the simulation is provided using the stored history information.

### BACKGROUND OF THE INVENTION

1. Field of the Invention

The present invention relates generally to the data processing field and, more particularly, to a computer implemented method, system and computer program product for providing a waveform trace for a last plurality of cycles of a simulation prior to occurrence of an error in the simulation without having to re-start the simulation from the beginning.

2. Description of the Related Art

Simulation time of a testcase to verify a specific functionality of a complex, multimillion gate chip can take hours or days to complete and can require millions of simulation cycles. Examples for such jobs include POR (Power on Reset) and ABIST (Array Built-In Self Test) simulation runs.

When errors occur during a simulation, the testcase must be rerun from the beginning in order to create waveform traces that are needed for error debugging. This time consuming generation of waveforms by rerunning the entire software-based simulation is a major bottleneck in verification and can hinder further testing of a chip resulting in slippage of a verification schedule and a reduction of simulation coverage.

Typical Hardware Description Language (HDL) software simulators offer functions to create waveform traces for a period of cycles specified during the start of a simulation or by using a special command which starts a waveform trace beginning with the actual simulation cycle. HDL software simulators, however, provide no mechanism that enables a testcase to create a waveform trace for numerous simulation cycles just prior to when an error has occurred (because many errors in a simulation are triggered by events that occur well before the errors can be detected by outputs of the simulation) but without having to access waveforms significantly before occurrence of the error, i.e., from the beginning of the simulation with a set of additional parameters to specify when to capture the waveform trace.

There is, accordingly, a need for a mechanism, in a data processing system, for providing a waveform trace for a last plurality of cycles of a simulation prior to occurrence of an error in the simulation without having to re-start the simulation from the beginning.

### SUMMARY OF THE INVENTION

Exemplary embodiments provide a computer implemented method, system and computer program product for providing a waveform trace of a last plurality of cycles of a simulation prior to occurrence of an error in the simulation. A computer implemented method in a data processing system for providing a waveform trace for a last plurality of cycles of a simulation prior to occurrence of an error in the simulation includes storing history information relating to a last plurality of cycles of a simulation during running of the simulation. Responsive to an error occurring in the simulation, the simulation is stopped, and a waveform trace for the last plurality of cycles of the simulation is provided using the stored history information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a block diagram of a Hardware Description Language (HDL) simulator system according to an exemplary embodiment;

FIG. 4 is a diagram that schematically illustrates a method for providing a waveform trace for a last plurality of cycles of a simulation prior to occurrence of an error in the simulation according to an exemplary embodiment;

FIG. 5 is a diagram that schematically illustrates a method for providing a waveform trace for a last plurality of cycles of a simulation prior to occurrence of an error in the simulation according to a further exemplary embodiment; and

FIG. 6 is a flowchart that illustrates a method for providing a waveform trace for a last plurality of cycles of a simulation prior to occurrence of an error in the simulation according to an exemplary embodiment.

### DETAILED DESCRIPTION OF THE PREFERRED EMBODIMENT

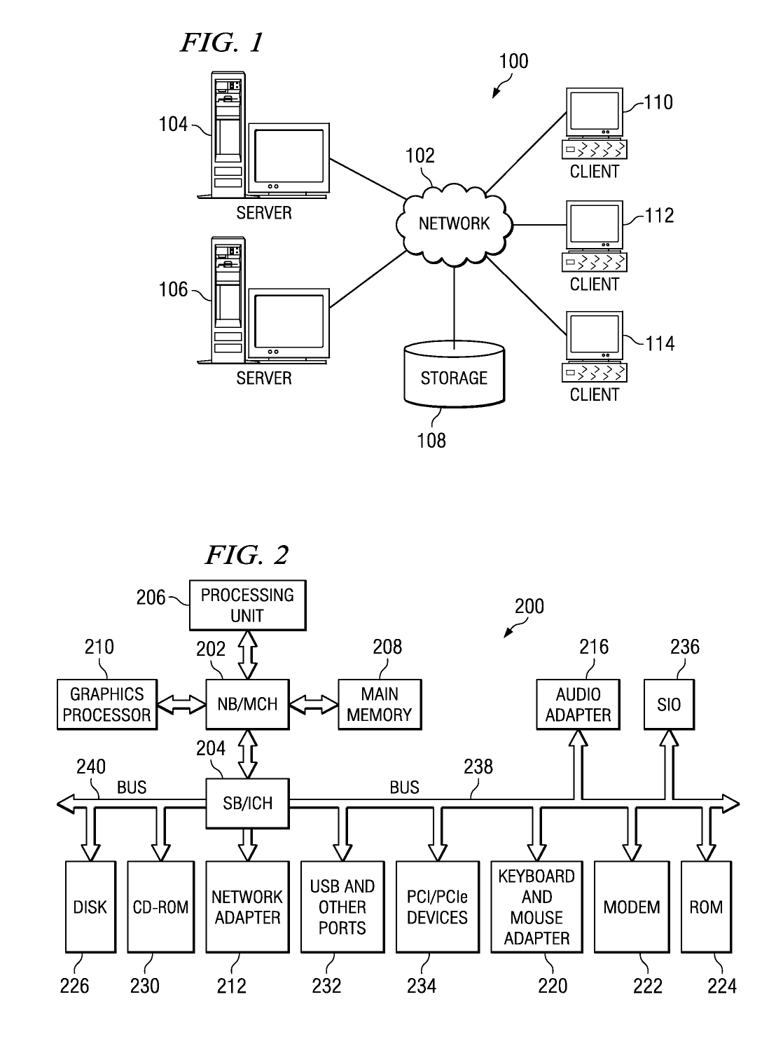

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications, to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP. (Microsoft and Windows are trademarks of Microsoft Corporation in the United States, other countries, or both.) An object oriented programming system, such as the Java™ programming system, may run in conjunction with the operating system and provide calls to the operating system from Java programs or applications executing on data processing system 200. (Java and all Java-based trademarks are trademarks of Sun Microsystems, Inc. in the United States, other countries, or both.)

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations.

Exemplary embodiments provide a mechanism in a simulator in a data processing system, for example, a Hardware Description Language (HDL) simulator, for providing a waveform trace for a last plurality of cycles of a simulation prior to occurrence of an error in the simulation without having to restart the simulation from the beginning of the simulation.

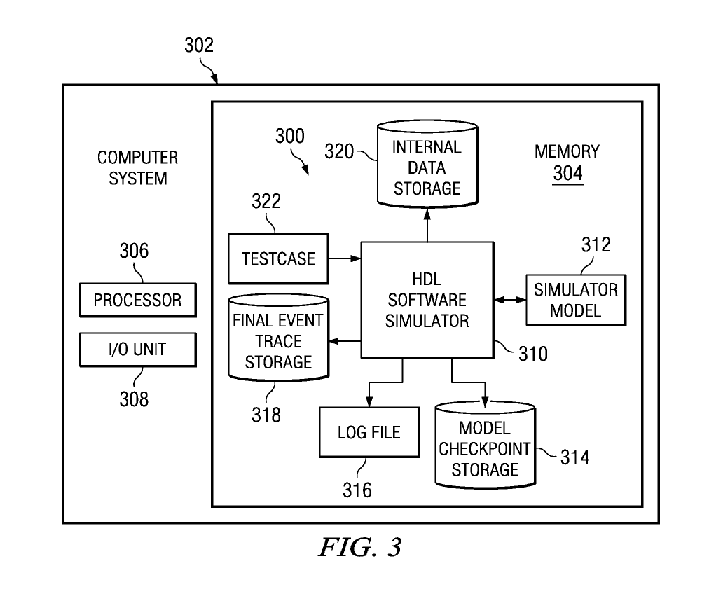

FIG. 3 is a block diagram of a Hardware Description Language (HDL) simulator system according to an exemplary embodiment. The simulator system is generally designated by reference number 300 and is incorporated in computer system 302. Computer system 302 can be implemented, for example, as data processing system 200 in FIG. 2. Computer system 302 generally includes memory 304, processor 306, and input/output (I/O) unit 308.

HDL simulator system 300 is stored within computer memory 304, and generally includes HDL software simulator 310, simulator model 312, model checkpoint storage 314, log file 316, final event trace storage 318 and storage for various internal data 320. Testcase 322, also stored in memory 304, can be input into simulator 310 to run a simulation. As will be explained in greater detail hereinafter, model checkpoint storage 314 periodically stores checkpoints during the running of a simulation, log file 316 stores a log for all stimuli received in a timeframe between two stored checkpoints, and final event trace storage 318 stores a last chunk of a waveform trace during the running of a simulation.

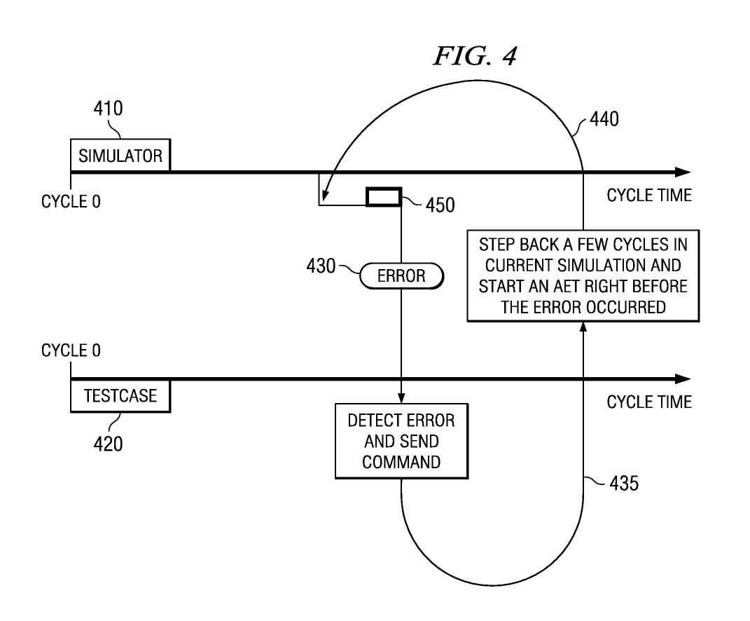

FIG. 4 is a diagram that schematically illustrates a method for providing a waveform trace for a last plurality of cycles of a simulation prior to occurrence of an error in the simulation according to an exemplary embodiment. At the beginning of a simulation, at cycle zero, simulator 410 starts to periodically store checkpoints in model checkpoint storage 314 illustrated in FIG. 3; and, in addition, starts to maintain a log for all stimuli received in the timeframe between two consecutive checkpoints stored in log file 316, also illustrated in FIG. 3. During running of the simulation, it is assumed that error 430 occurs. Testcase 420 detects error 430 and sends a command to simulator 410 forcing the simulator to stop the current simulation as indicated by arrow 435. Simulator 410 then steps back a few cycles, for example, 100 cycles before the error occurred, as indicated by arrow 440 and starts re-simulating a last plurality of cycles of the simulation, i.e., starts an “All Events Trace” (AET) prior to occurrence of the error as illustrated at 450.

In particular, when error 430 occurs, model checkpoint storage 314 will store the last checkpoint that was stored prior to occurrence of the error, and log file 316 will contain all stimuli received in the time frame from the stored last checkpoint until the error occurred. Therefore, when the re-simulation is started a few cycles before the error occurred, it is only necessary to load the last checkpoint from model checkpoint storage 314 into the simulator and reapply all stimuli from log file 316 until the error cycle is again reached. During the re-simulation, a waveform trace for the last few cycles before the error will be automatically created.

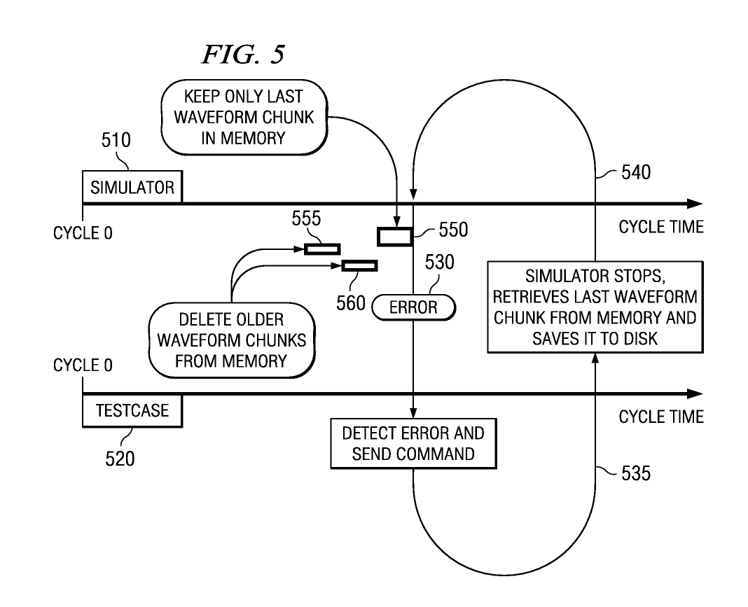

FIG. 5 is a diagram that schematically illustrates a method for providing a waveform trace for a last plurality of cycles of a simulation prior to occurrence of an error in the simulation according to a further exemplary embodiment. In FIG. 5, at the beginning of a simulation, at cycle zero, simulator 510 begins to automatically create waveform traces for chunks of waveforms, for example, 250 cycles each, which are stored in final event trace storage 318 illustrated in FIG. 3. During running of the simulation (before the occurrence of a problem), only the last chunk 550 of waveforms is kept in memory and all previously stored chunks, e.g., chunks 555 and 560, are removed as new chunks are stored.

During running of the simulation, it is assumed that error 530 occurs. Testcase 520 detects the error and sends a command to simulator 510 which forces the simulator to stop the current simulation as indicated by arrow 535. Simulator 510 then retrieves the last chunk of waveform 550 saved in memory and stores it to a disk or another non-volatile storage device as indicated by arrow 540. A waveform trace of the last plurality of cycles of the simulation prior to occurrence of the error is thus automatically provided.

It is to be noted that log file 316 and model checkpoint storage 314 are not required and can be omitted from HDL simulator system 300 for this exemplary embodiment, whereas final event trace storage 318 is not needed and can be omitted for the exemplary embodiment in FIG. 4.

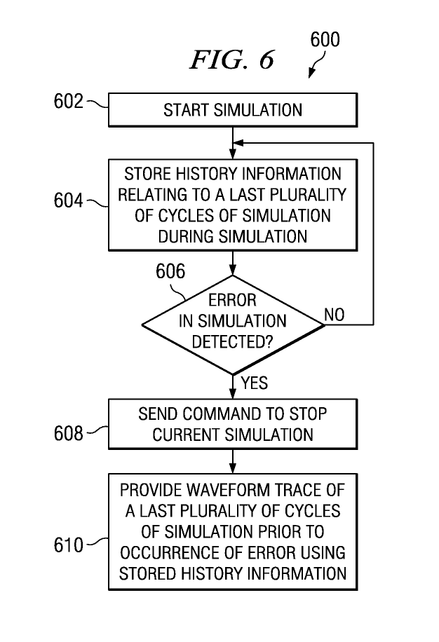

FIG. 6 is a flowchart that illustrates a method for providing a waveform trace for a last plurality of cycles of a simulation prior to occurrence of an error in the simulation according to an exemplary embodiment. The method is generally designated by reference number 600 and begins by starting a simulation (Step 602). During the running of the simulation, history information relating to a last plurality of cycles of the simulation is stored (Step 604). According to one exemplary embodiment, the history information can be a checkpoint and a log of all stimuli received in a timeframe between the checkpoint and the occurrence of an error. According to an alternative embodiment, the history information can be a last chunk of waveforms that has been stored during the running of the simulation.

A determination is then made as to whether an error is detected during the running of the simulation (Step 606). If no error is detected (No output of Step 606), the system continues to run the simulation. If, however, an error is detected (Yes output of Step 606), a command is sent to the software simulator which forces the simulator to stop the current simulation (Step 608). A waveform trace for the last plurality of cycles of the simulation prior to occurrence of the error is automatically provided using the stored history information (Step 610).

In accordance with exemplary embodiments, a testcase does not need to be rerun with an additional set of parameters in order to capture a waveform trace when an error occurs during the running of a simulation. Accordingly, it is unnecessary to re-simulate the testcase from the beginning of a simulation, which can save hours or even days of simulation time. The exemplary embodiments are thus particularly useful in large designs where it is substantially impossible to store all signal values for the whole time span of a simulation because of memory space limitations.

Exemplary embodiments thus provide a computer implemented method, system and computer program product for providing a waveform trace of a last plurality of cycles of a simulation prior to occurrence of an error in the simulation. A computer implemented method in a data processing system for providing a waveform trace for a last plurality of cycles of a simulation prior to occurrence of an error in the simulation includes storing history information relating to a last plurality of cycles of a simulation during running of the simulation. Responsive to an error occurring in the simulation, the simulation is stopped, and a waveform trace for the last plurality of cycles of the simulation is provided using the stored history information.

The invention can take the form of an entirely hardware embodiment, an entirely software embodiment or an embodiment containing both hardware and software elements. In a preferred embodiment, the invention is implemented in software, which includes but is not limited to firmware, resident software, microcode, hardware acceleration devices, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or hardware acceleration devices or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method in a data processing system for creating a waveform trace for a last plurality of cycles of a simulation prior to occurrence of an error in the simulation, the computer implemented method comprising:
storing history information relating to a last plurality of cycles of a simulation during running of the simulation; and
responsive to an error occurring in the simulation,
stopping the simulation; and
providing a waveform trace for the last plurality of cycles of the simulation using the stored history information.

2. The computer implemented method according to claim 1, wherein storing history information relating to a last plurality of cycles of a simulation during running of the simulation comprises:
storing a last checkpoint that was set prior to occurrence of the error and all stimuli received in a timeframe between the stored last checkpoint and the occurrence of the error.

3. The computer implemented method according to claim 2, wherein providing a waveform trace for the last plurality of cycles of the simulation using the stored history information comprises:
creating a waveform trace for the last plurality of cycles of the simulation by reapplying the stored stimuli received in the timeframe between the stored last checkpoint and the occurrence of the error.

4. The computer implemented method according to claim 2, and further comprising:
periodically storing checkpoints and all stimuli received in a timeframe between two consecutive checkpoints during running of the simulation; and wherein storing a last checkpoint that was set prior to occurrence of the error and all stimuli received in the timeframe between the stored last checkpoint and the occurrence of the error comprises:
periodically replacing previously stored checkpoints and stimuli with currently stored checkpoints and stimuli during running of the simulation.

5. The computer implemented method according to claim 2, wherein the last plurality of cycles comprises about 100 cycles.

6. The computer implemented method according to claim 1, wherein storing history information relating to a last plurality of cycles of a simulation during running of the simulation comprises:
storing a last chunk of a waveform during running of the simulation.

7. The computer implemented method according to claim 6, wherein storing a last chunk of a waveform during running of the simulation comprises:
periodically replacing previously stored chunks of waveforms with a currently stored chunk of a waveform during running of the simulation.

8. The computer implemented method according to claim 6, wherein providing a waveform trace for the last plurality of cycles of the simulation using the stored history information comprises:
retrieving the last stored chunk of a waveform and storing it to a non-volatile storage device.

9. The computer implemented method according to claim 6, wherein the last chunk of a waveform comprises about 250 cycles.

10. The computer implemented method according to claim 1, wherein the simulator comprises a Hardware Description Language software simulator.

11. A computer program product, comprising:
a computer usable medium having computer usable program code for creating, in a data processing system, a waveform trace for a last plurality of cycles of a simulation prior to occurrence of an error in the simulation, the computer program product comprising:
computer usable program code configured for storing history information relating to a last plurality of cycles of a simulation during running of the simulation; and
responsive to an error occurring in the simulation,
computer usable program code configured for stopping the simulation; and
computer usable program code configured for providing a waveform trace for the last plurality of cycles of the simulation using the stored history information.

12. The computer program product according to claim 11, wherein the computer usable program code configured for storing history information relating to a last plurality of cycles of a simulation comprises:
computer usable program code configured for storing a last checkpoint that was set prior to occurrence of the error and all stimuli received in a timeframe between the stored last checkpoint and the occurrence of the error.

13. The computer program product according to claim 12, wherein the computer usable program code configured for providing a waveform trace for the last plurality of cycles of the simulation using the stored history information comprises:
computer usable program code configured for creating a waveform trace for the last plurality of cycles of the simulation by reapplying the stored stimuli received in the timeframe between the stored last checkpoint and the occurrence of the error.

14. The computer program product according to claim 12, and further comprising:
computer usable program code configured for periodically storing checkpoints and all stimuli received in a timeframe between two consecutive checkpoints during running of the simulation; and wherein the computer usable program code configured for storing a last checkpoint that was set prior to occurrence of the error and all stimuli received in the timeframe between the stored last checkpoint and the occurrence of the error comprises:
computer usable program code configured for periodically replacing previously stored checkpoints and stimuli with currently stored checkpoints and stimuli during running of the simulation.

15. The computer program product according to claim 11, wherein the computer usable program code configured for storing history information relating to a last plurality of cycles of a simulation comprises:
computer usable program code configured for storing a last chunk of a waveform during running of the simulation by periodically replacing previously stored last chunks of waveforms with a currently stored last chunk of a waveform during running of the simulation.

16. The computer program product according to claim 15, wherein the computer usable program code configured for providing a waveform trace for the last plurality of cycles of the simulation using the stored history information comprises:
computer usable program code configured for retrieving the currently stored last chunk of a waveform and storing it to a non-volatile storage device.

17. A system for creating a waveform trace for a last plurality of cycles of a simulation prior to occurrence of an error in the simulation, the system comprising:
a storage for storing history information relating to a last plurality of cycles of a simulation during running of the simulation; and
responsive to an error occurring in the simulation,
a mechanism for stopping the simulation; and
a mechanism for providing a waveform trace for the last plurality of cycles of the simulation using the stored history information.

18. The system according to claim 17, wherein the history information comprises a last checkpoint that was set prior to occurrence of the error and all stimuli received in a timeframe between the stored last checkpoint and the occurrence of the error, and wherein the mechanism for providing a waveform trace for the last plurality of cycles of the simulation using the stored history information comprises:
a mechanism for creating a waveform trace of the last plurality of cycles of the simulation by reapplying the stored stimuli received in the timeframe between the stored last checkpoint and the occurrence of the error.

19. The system according to claim 17, wherein the history information comprises a last chunk of a waveform during running of the simulation, and wherein the mechanism for providing a waveform trace for the last plurality of cycles of the simulation using the stored history information comprises a mechanism for retrieving the last stored chunk of a waveform and storing it to a non-volatile storage device.

20. The system according to claim 17, wherein the simulator comprises a Hardware Description Language software simulator.
